(19) United States
(12) Patent Application Publication
(10) Pub. No.: US 2009/0298887 A1
(43) Pub. Date: Dec. 3, 2009

(54) METHOD FOR IMPROVING HARVESTED SEED QUALITY

(75) Inventor: Clifford Watrin, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(73) Assignee: Syngenta Corp Protection, Inc., Greensboro, NC (US)

(21) Appl. No.: 11/720,856

(22) PCT Filed: Dec. 8, 2005
(86) PCT No.: PCT/US05/44330

§ 371 Date: Aug. 10, 2009

Related U.S. Application Data
(60) Provisional application No. 60/634,478, filed on Dec. 9, 2004.

(51) Int. Cl. A01N 53/06; A01N 47/40; A01N 43/40; A01N 51/00; A01N 43/56; A01P 7/04

(52) U.S. Cl. 514/341; 514/342; 514/357; 514/365; 514/407; 514/471; 514/520

(57) ABSTRACT

The present invention is directed to a method for improving the quality of seeds harvested from seed-producing plants. The method comprises treating the pre-planted seeds of the seed-producing plants with a seed treatment insecticide and treating the resulting plant with foliar applications of a foliar insecticide; or treating the pre-planted seeds of the seed-producing plants with a seed treatment insecticide; or treating seed-producing plants with foliar applications of a foliar insecticide.

The present invention is directed to a method for improving the quality of seeds harvested from seed-producing plants, the method comprising treating the pre-planted seeds of the seed-producing plants with a seed treatment insecticide and treating the resulting plant with foliar applications of an insecticide; or treating the pre-planted seeds of the seed-producing plants with a seed treatment insecticide; or treating seed-producing plants with foliar applications of an insecticide.

Growers optimize economic benefits from their crops in several ways. First, they harvest and sell the fruits of those crops. Additionally, however, the seeds generated by seed-producing plants are harvested and sold for profit.

Seed borne diseases are known to be major contributors to reduced seed quality, resulting in reduced germination, reduced plant stand establishment, reduced plant vigor, and reduced plant yield. Because seed borne diseases readily transfer from seed to seed in a given lot, rampant infection by seed borne diseases often results in seed lots being rejected by seed companies. Such rejection leads to lost profits for the seed companies, as many plants, especially hybrids and varieties grown specifically for seed generation, are deemed unmarketable if the quality of the plants used to produce seeds is low.

The presence of seed borne diseases can also adversely impact the growth of a crop. Infected seeds may fail to germinate or may result in diseased plants, resulting in losses associated with growers' failed crops, unused and wasted growing space and unmarketable plants.

Seed borne diseases originate from several sources. Some seeds are inherently of poor quality and subject to infection. Others develop fungal infections by exposure to fungal pathogens. Additionally, seeds may become diseased or deteriorate due to the presence of pests such as insects.

Growers counteract the problems associated with seed borne diseases by treating the seeds against such attacks. Treatment of seeds with fungicides is known to prevent the spread of fungal pathogens, while treatment of seeds with insecticides is known to minimize the damage done by pest attacks.

Foliar treatment of crops is also known in the art. By treating plant materials with agrochemicals, the grower aims to preserve the health of the plant until harvested and to eliminate the presence of destructive pests.

It has now been surprisingly found that treatment of the seed of a seed-producing plant with a seed treatment insecticide or treatment of the seed-producing plant with a foliar insecticide, or both, treatment of the seed of a seed-producing plant with a seed treatment insecticide followed by treatment of the resulting germinated seed-producing plant with a foliar insecticide produces seeds for harvest which have higher quality. Specifically, the resulting seeds possess higher germination rates, greater plant stand and vigor. This higher quality of harvested seeds results in seed lots having better quality. Consequently, the value of a seed lot is higher and there is less waste associated with discarded, diseased seeds.

### DETAILED DESCRIPTION OF THE INVENTION

Seed treatment insecticides include fipronil and neonicotinoid insecticides. Neonicotinoid insecticides include, but are not limited to, thiamethoxam, acetamiprid, clothianidin, dinotefuran, imidacloprid, nitenpyram, and thiacloprid. See, for example, the Pesticide Manual, 13th Ed. (2004), The British Crop Protection Council, London.

Preferred seed treatment insecticides include fipronil, thiamethoxam, clothianidin, and imidacloprid. Particularly preferred neonicotinod insecticides include thiamethoxam, clothianidin, and fipronil.

Foliar insecticides include organophosphorus compounds, nitrophenols and derivatives, formamidines, triazine derivatives, nitroenamine derivatives, nitro- and cyanoguanidine derivatives, ureas, benzoylureas, carbamates, pyrethroids, chlorinated hydrocarbons and Bacillus thuringiensis products. Preferred foliar insecticides include, but are not limited to, pyrethroids, triazine derivatives, and carbamates. Particularly preferred foliar insecticides include pyrethroids. Pyrethroids include, but are not limited to, alpha-cypermethrin, beta-cyfluthrin, beta-cypermethrin, bifenthrin, bioresmethrin, cycloprothrin, cylluthrin, cypermethrin, deltamethrin, esfenvalerate, fenpropathrin, fenvalerate, flucythrinate, gamma cyhalothrin, lambda cyhalothrin, permethrin, phenothrin (and isomers thereof), resmethrin, tau-fluvalinate, tefluthrin, tralomethrin, zeta-cypermethrin, and ZXI-8901. See, for example, the Pesticide Manual, 13th Ed. (2004), The British Crop Protection Council, London. Preferred pyrethroid insecticides include tefluthrin and lambda cyhalothrin. A most particularly preferred pyrethroid insecticide is lambda cyhalothrin.

Particularly useful seeds and plants treated by the method of the present invention include those subject to insects and pests associated with the development and spread of seed and plant disease infections. More particularly, maize, including field corn, sweet corn and popcorn, cotton, potatoes, cereals, (wheat, barley, rye, oats, rice), sugar beet, cotton, millet varieties such as sorghum, sun flowers, beans, peas, oil plants such as rape, soybeans, cabbages, tomatoes, eggplants (aubergines), pepper and other vegetables and spices as well as ornamental shrubs and flowers and turf seed are contemplated by the present invention. Seeds and plants treated by the present invention also include hybrids and genetically modified forms of the classes described above.

The compounds of this method are used in unmodified form or, preferably, together with the adjuvants conventionally employed in formulation technology. To this end they are conveniently formulated in known manner e.g. to emulsifiable concentrates, coatable pastes, directly sprayable or dilutable solutions, dilute emulsions, wettable powders, soluble powders, dusts, granulates, and also by encapsulation or impregnation, in e.g. polymer-like substances. As with the nature of the compositions, the methods of application, such as spraying, atomizing, dusting, scattering, coating tumbling, or pouring are chosen in accordance with the intended objectives and the prevailing circumstances recognized by one of ordinary skill in the art. Advantageous rates of application of the active ingredient mixture are normally from 0.5 g to 500 g, from 1 g to 100 g, or from 5 g to 50 g a.i. per 100 kg of seed.

In a particularly suitable method, the active ingredient seed treatment insecticide, particularly thiamethoxam or fipronil, may be applied to plant propagation material, i.e. to seeds, tubers, fruit or other plant materials to be protected (e.g. bulbs, coating) by impregnating the seeds or seed materials either with a liquid formulation of the insecticide or coating them with a solid formulation.

In another particularly suitable method, the active ingredient foliar insecticide, particularly lambda cyhalothrin, clothianidin, tefluthrin, or imidacloprid, may be applied to the plant material via any means known in the art. Preferably, foliar application of the insecticide is used. The term “foliar application” refers to the application of active ingredient to the foliage or aboveground portions of the plant, especially to the leaves of the plant. Application may be effected by any means known in the art. A particularly preferred mode of application is by spraying the active ingredient.

The formulations are prepared in known manner, typically by intimately mixing and/or grinding the active ingredients with extenders, e.g. solvents, solid carriers and, where appropriate, surface-active compounds (surfactants).

Suitable solvents are: aromatic hydrocarbons, the fractions containing 8 to 12 carbon atoms, typically xylene mixtures or substituted naphthalenes, phthalates such as dibutyl or dioctyl phthalate, aliphatic hydrocarbons such as cyclohexane or paraffins; alcohols and glycols and their ethers and esters such as monomethyl ether, ketones such as cyclohexanone, strongly polar solvents such as N-methyl-2-pyrrolidone, dimethyl sulfoxide or dimethyl formamide, as well as vegetable oils or epoxidised vegetable oils; or water.

The solid carriers typically used for dusts and dispersible powders are calcite, talcum, kaolin, montmorillonite or attapulgite, highly dispersed silicic acid or absorbent polymers. Suitable granulated adsorptive granular carriers are pumice, broken brick, sepiolite or bentonite, and suitable non-sorptive carriers are typically calcite or dolomite.

Depending on the nature of the active ingredients to be formulated, suitable surface-active compounds are nonionic, cationic and/or anionic surfactants having good emulsifying, dispersing and wetting properties. The term “surfactants” will also be understood as comprising mixtures of surfactants.

The surfactants customarily employed in formulation technology may be found in the following literature:
“McCutcheon's Detergents and Emulsifiers Annual” MC Publishing Corp., Glen Rock, N.J., 1988.
M. and J. Ash, “Encyclopedia of Surfactants”, Vol. I-III, Chemical Publishing Co., New York, 1980-1981.

By way of example, and not limitation, application-promoting adjuvants are also natural or synthetic phospholipids of the cephalin and lecithin series, e.g. phosphatidylethanolamine, phosphatidylserine, phosphatidylglycerol and lysolecithin.

The agrochemical compositions usually comprise 0.1 to 99%, preferably 0.1 to 95%, of active ingredients, 99.9 to 1%, preferably 99.9 to 5%, of a solid or liquid adjuvant, and 0 to 25%, preferably 0.1 to 25%, of a surfactant.

Whereas commercial products or wet or dry dressings will preferably be formulated as concentrates, the end user will normally use dilute formulations for treating plants or seeds as the case may be. However, ready to apply dilute solutions also are within the scope of the present invention.

The quality or health of a harvested seed is measured as a combination of several factors including plant stand, germination, and plant vigor. Plant stand is measured as the density of crops per given area. Germination is a measurement of the number of seeds sprouting. Vigor is a measurement of the plant's ability to survive and grow when planted in a standard environment.

Seed germination testing is used to assess seed quality or viability and to predict performance of the seed and seedling in the field. Several different kinds of testing are available depending on the type of seed to be tested, the conditions of the test, and the potential uses of the seed. Two common tests are the warm germination test and the accelerated aging test. Each test is designed to evaluate various qualities of the seed. Factors that can affect the performance of seed in germination tests include; diseased seed, old seed, mechanically damaged seed, seed stored under high moisture, and excessive heating of seed during storage or drying.

A preferred test of seed germination is a warm germination test because it is used for labeling purposes. Germination is defined as: “the emergence and development from the seed embryo of those essential structures which are indicative of the ability to produce a normal plant under favorable conditions.” The warm germination test reflects the stand producing potential of a seed lot under ideal planting conditions. In a typical warm germination test, 400 seeds from each seed lot are placed under moist conditions on blotters, rolled towels, or sand and maintained at 77° F. for about seven days. At the end of this period the seedlings are categorized as normal, abnormal, or diseased, and dead or hard seeds. The percentage germination is calculated from the number of normal seedlings from the total number of seeds evaluated.

Another germination test, the accelerated aging test (AA), estimates the carryover potential of a seed lot in warehouse storage. The seeds are exposed to high temperatures and high relative humidity for short periods of time that cause seed deterioration. Seeds are suspended over water in a chamber for a period of time, for example 72 hours (wheat and soybeans) or 96 hours (corn), then tested in a standard warm germination test. This test only is usually used on seed whose longevity was in question.

### EXAMPLE 1

In the method of the present invention, seeds harvested from plants treated with a foliar insecticide, or seeds harvested from plants whose pre-planted seeds were treated with a seed treatment insecticide, or seeds harvested from plants that underwent both treatments, both as the pre-planted seed (seed treatment) and as the post emergent plant (foliar insecticide treatment) were tested in warm germination and accelerated aging tests to determine the health and quality of the harvested seeds. In accordance with the germination tests, it was discovered that seed-producing plants resulting from the growers' application of insecticides at the seed stage, the foliar stage, and both, not only were healthier plants, but they also produced healthier seeds. It was discovered that seeds harvested from these treated plants possessed greater health, resulting in a healthier seed lot.

Germination studies were conducted on soybean plants comparing plants treated with a combination of fungicides with plants (1) wherein only insecticidal seed treatment was applied; (2) wherein insecticidal seed treatment was applied followed by foliar insecticidal treatment on the resulting plant; and (3) wherein only foliar insecticide was applied to a plant grown from untreated seed. The results are provided in Table 1.

TABLE 1

| | Warm Germination | Accelerated Aging |
|---|---|---|
| Treatment | (+/−Std. Error) | (+/−Std. Error) |
| Fludioxonil + Mefenoxam | 91.8 (0.63) | 86.6 (0.95) |
| Thiamethoxam 30 g | 91.4 (0.63) | 86.7 (0.95) |
| Thiamethoxam 50 g | 91.6 (0.65) | 90.4 (0.98) |
| Thiomethoxam 50 g + | 93.2 (0.70) | 90.7 (1.06) |
| lambda cyhalothrin | | |
| (2 applications) | | |
| lambda cyhalothrin | 92.5 (0.70) | 89.3 (1.06) |
| (2 applications) | | |
| lambda cyhalothrin (8/8) | 92.9 (0.81) | 89.7 (1.23) |
| lambda cyhalothrin (8/12) | 91.1 (0.81) | 86.5 (1.23) |

As various changes could be made in the above methods and compositions without departing from the scope of the invention, it is intended that all matter contained in the above description shall be interpreted as illustrative and not in a limiting sense.

We claim:

1. A method for increasing the quality of a seed produced by a seed-producing plant comprising
a. treating a pre-planted seed of a seed-producing plant with a seed treatment insecticide; or
b. treating a seed-producing plant with a foliar application of a foliar insecticide; or
c. treating a pre-planted seed of a seed-producing plant with a seed treatment insecticide and treating the resulting germinated plant with a follar application of a foliar insecticide.

2. The method according to claim 1, wherein the pre-planted seed Is treated with a seed treatment insecticide and the resulting germinated plant is treated with a foliar application of a foliar insecticide.

3. The method according to claim 2, wherein the seed treatment insecticide is selected from the group consisting of thiamethoxam, fipronil, acetamiprid, clothianidin, dinotefuran, imidacloprid, nitenpyram, and thiacloprid.

4. The method according to claim 3, wherein the seed treatment insecticide is selected from the group consisting of thiamethoxam, fipronil, clothianidin, and imidaclopdid.

5. The method according to claim 3, wherein the seed treatment insecticide is thiamethoxam.

6. The method according to claim 3, wherein the seed treatment insecticide is clothianidin.

7. The method according to claim 3, wherein the seed treatment insecticide is imidacloprid.

8. The method according to claim 3, wherein the seed treatment insecticide is fipronil.

9. The method according to claim 2, wherein the foliar insecticide is a pyrethroid insecticide selected from the group consisting of alpha-cypermethrin, beta-cyfluthrin, beta-cypermethrin, bifenthrin, bioresmethrin, cycloprothrin, cyfluthrin, cypermethrin, deltamethrin, esfenvalerate, fenpropathrin, fenvalerate, flucythrinate, gamma cyhalothrin, lambda cyhalothrin, permethrin, phenothrin (and isomers thereof), resmethrin, tau-fluvalinate, tefluthrin, tralomethrin, zeta-cypermethrin, and ZXI-8901.

10. The method according to claim 8, wherein the pyrethroid insecticide is selected from the group consisting of lambda cyhalothrin and tefluthrin.

11. The method according to claim 9, wherein the pyrethroid insecticide is lambda cyhalothrin.

12. The method according to claim 2, wherein the seed treatment insecticide is thiamethoxam and the foliar insecticide is lambda cyhalothrin.

13. The method according to claim 1, wherein the pre-planted seed is treated with a seed treatment insecticide.

14. The method according to claim 12, wherein the seed treatment insecticide is selected from the group consisting of thiamethoxam, fipronil, acetamiprid, clothianidin, dinotefuran, imidacloprid, nitenpyram, and thiacloprid.

15. The method according to claim 13, wherein the seed treatment insecticide is selected from the group consisting of thiamethoxam, fipronil, clothianidin, and imidacloprid.

16. The method according to claim 13, wherein the seed treatment insecticide is thiamethoxam.

17. The method according to claim 13, wherein the seed treatment insecticide is clothianidin.

18. The method according to claim 13, wherein the seed treatment insecticide is imidacloprid.

19. The method according to claim 13, wherein the seed treatment insecticide is fipronil.

20. The method according to claim 1, wherein a seed-producing plant is treated with a foliar application of a foliar insecticide.

21. The method according to claim 18, wherein the foliar insecticide is a pyrethroid insecticide selected from the group consisting of alpha-cypermethrin, beta-cyfluthrin, beta-cypermethrin, bifenthrin, bioresmethrin, cycloprothrin, cyfluthrin, cypermethrin, deltamethrin, esfenvalerate, fenpropathrin, fenvalerate, flucythrinate, gamma cyhalothrin, lambda cyhalothrin, permethrin, phenothrin (and isomers thereof), resmethrin, tau-fluvalinate, tefluthrin, tralomethrin, zeta-cypermethrin, and ZXI-8901.

22. The method according to claim 19, wherein the pyrethroid insecticide is selected from the group consisting of lambda cyhalothrin and tefluthrin.

23. The method according to claim 20, wherein the pyrethroid insecticide is lambda cyhalothrin.
